(19) United States
(12) Patent Application Publication
(10) Pub. No.: US 2006/0286324 A1
(43) Pub. Date: Dec. 21, 2006

(54) Plastic package

(76) Inventor: Achim Helmenstein, Engelskirchen (DE)

Correspondence Address: JACOBSON HOLMAN PLLC, 400 SEVENTH STREET N.W., SUITE 600, WASHINGTON, DC, 20004, US

(21) Appl. No.: 11/454,132

(22) Filed: Jun. 16, 2006

(30) Foreign Application Priority Data
Jun. 17, 2005 (DE) 10 2005 028 148.6

(51) Int. Cl. B32B 27/08

(52) U.S. Cl. 428/35.7

(57) ABSTRACT

A flexible package of plastic with at least one wall, the wall comprising a polymer mixture of at least two components selected from: a) a polypropylene copolymer having a flexural modulus of elasticity of at most 800 MPa and a melt flow rate of at most 600 g/10 min (2.16 kg, 230° C.); b) a polypropylene other than that of component a) and having a melt flow rate of from 20 to 600 g/10 min (2.16 kg, 230° C.); and c) a polyolefin other than a polypropylene; wherein, if only component a) and component b) are present, component b) is a polypropylene copolymer; and wherein, if only component a) and component c) are present, component c) has a melt flow rate of at least 15 g/10 min (2.16 kg, 230° C.).

The present invention relates to a flexible package of plastic, a polymer mixture for preparing said flexible package of plastic, and a process for preparing said flexible package of plastic.

Flexible packages, such as collapsible tubes, are employed for dosing a wide variety of products, for example, in the fields of cosmetics, foods, adhesives, sealants etc.

Typically, such flexible packages are prepared in two parts. Thus, an extruded plastically deformable plastic tubing is cut to the desired length and subsequently bonded to a head piece prepared in a separate process step. Basically, it is desirable to prepare such products in one piece in order to keep the production expenditure as low as possible.

WO 2005/019053 describes a process for preparing such a package, especially a collapsible tube, which process enables the preparation of highly dimensionally stable collapsible tubes in an injection molding process.

EP 1 418 205 A1 (Sonoco Development Inc.) already describes a composition for the preparation of corresponding collapsible tubes by injection molding. Thus, polypropylenes are employed which have very high melt flow indices (MFI) or melt flow rates (MFR) of more than 800 g/10 min. Such materials are very readily flowable and well suited for injection molding. However, the flexibility, stress-cracking resistance and further qualitative features of the collapsible tubes obtained therefrom do not correspond to those of the collapsible tubes prepared in two parts in the usual process.

U.S. Pat. No. 6,124,008 (L'Oreal) describes an injection-molded plastic container which has a wall consisting of a polymer mixture of an ethylene/C₄-C₅ olefin copolymer and an ethylene/C₆-C₁₀ olefin copolymer. These packages either will be prepared with great difficulty in an injection-molding process due to the low flowability of the obtainable materials, or, if a higher flowability can be adjusted in the material, poorer properties in terms of stress-cracking resistance are to be expected. Further, copolymers with contents of C₆-C₁₀ olefin are relatively expensive.

U.S. Pat. No. 6,159,566 (L'Oreal) discloses a thermoplastic material and a collapsible tube prepared therefrom. Thus, a polymer mixture is employed which consists of a first polymer, a homopolymer of propylene and a second polymer, a propylene ethylene copolymer. In order to reduce the high stiffness of the polypropylene homopolymer and to increase its toughness or (cold) impact resistance, significant proportions of a special propylene ethylene copolymer are required, which has a very low flexural modulus of elasticity and is available only at a relative high price.

U.S. 2002/0039630 describes a container which contains a wall of polypropylene having a flexural modulus of elasticity of at least 1200 MPa and an LD or VLD polyethylene. Due to the high flexural modulus of elasticity of polypropylene, the product does not have the desired flexibility for many applications.

DE 202 02 854 U1 deals with plastic collapsible tubes prepared in an extrusion process in which the plastic of the first layer has at least 50% by weight of methacrylic acid copolymer.

DE 102 07 701 B4 discloses a plastic collapsible tube of a deformable modified polyethylene prepared by an extrusion process.

These one-layer or multilayer plastic collapsible tubes prepared by an extrusion process have the disadvantage that the sleeve and shoulder of the collapsible tube must be prepared separately in two production steps and subsequently joined with a high production expenditure. Thus, different material structures and properties for the shoulder and sleeve of the collapsible tube are also produced.

Therefore, there is an ongoing need for suitable materials for preparing flexible plastic packages, especially materials suitable for use in injection molding as well as corresponding plastic packages.

It was the object of the invention to overcome at least some of the mentioned drawbacks of the prior art.

This object is achieved by a flexible package of plastic with at least one wall, the wall comprising a polymer mixture of at least two components selected from:
a) a polypropylene copolymer having a flexural modulus of elasticity of at most 800 MPa and a melt flow rate of at most 600 g/10 min (2.16 kg, 230° C.);
b) a polypropylene other than that of component a) and having a melt flow rate of from 20 to 600 g/10 min (2.16 kg, 230° C.); and
c) a polyolefin other than a polypropylene;
   wherein, if only component a) and component b) are present, component b) is a polypropylene copolymer; and
   wherein, if only component a) and component c) are present, component c) has a melt flow rate of at least 15 g/10 min (2.16 kg, 230° C.).

In extensive experiments, it has been found that the combination according to the invention yields materials from which plastic packages, especially collapsible tubes, can be prepared whose properties are either substantially equal or even superior to those of usual packages prepared in two parts. The products according to the invention are characterized by a good production property by injection molding and are economically advantageous.

In the experiments performed, it has been established that the stiffness or deformability, stress-cracking resistance, flowability, transparency and economic efficiency (cost of raw materials in this case) can be adapted very well to the desired package performance within technically reasonable limits by selectively changing the quantitative ratios of the individual components.

“Polymer” within the meaning of this application includes both homopolymers and copolymers.

“Copolymers” within the meaning of this application are polymers in which different monomers are polymerized together, simultaneously or successively. This is typically effected in the presence of catalysts and may be done in one or more reactors or reactor steps. The term “copolymer” includes every possible copolymerization variant, such as alternating, block, graft and random copolymers, as well as all copolymers of a heterophasic design. It also includes atactic, syndiotactic and isotactic copolymeric chain structures. The copolymers may be in a non-cross-linked as well as cross-linked form. The term also includes all polymers which contain more than two monomers, such as terpolymers, The molecular structure may be amorphous or partly crystalline.

A copolymer contains at least 50% of the mentioned substance, i.e., a polypropylene copolymer contains at least 50% of propylene monomers, an ethylene copolymer contains at least 50% of ethylene monomers, etc.

A polypropylene copolymer is employed as component a). This is a compound which may contain propylene as one monomer and up to 50% by weight of another monomer, e.g., ethylene. Copolymers of propylene with other monomers, such as butene (C₄), hexene (C₆), octene (C₈) or even longer-chain olefins, may also be employed.

Also conceivable are, for example, cross-linked or branched ethylene/propylene (diene) copolymers (EPDM) in a crystalline or amorphous structure. Such materials are available, for example, from the company Huls under the trade name Buna®, from the company Monsanto under the trade name Santoprene®, from the company Bayer under the trade name Levaflex®, or from the company Exxon Chemical under the trade name Vistalon®.

The material components according to the invention have a flexural modulus of elasticity determined according to ASTM D-709. The material for component a) according to the invention preferably has a flexural modulus of elasticity of at most 600 MPa, more preferably of at most 200 MPa. The flexural modulus of elasticity is preferably at least 20 MPa, preferably not below 25 MPa. Corresponding materials can be obtained, for example, under the name of Adflex® from the company Basell. Corresponding grades include, for example, Z108S or X100G. These materials mentioned illustratively are heterophasic copolymers. In a first reactor step, a matrix of a homopolymeric polypropylene or a randomly copolymerized polypropylene is prepared. In a further reactor step, a propylene/ethylene rubber is added. The result is a heterophasic copolymer composite of polypropylene and a propylene/ethylene rubber. In this process, an propylene/ethylene rubber proportion of the total polymer of up to from 85 to 90% by weight can be introduced, wherein the ethylene proportion in this ethylene/propylene rubber may also be up to 50% by weight. Accordingly, the proportion of ethylene in the total polypropylene copolymer reaches maximally 45% by weight. Further, this material for component a) is characterized by low values of the flexural modulus of elasticity. The material has a good stress-cracking resistance, but it is relatively expensive. Its flow properties result in a non-optimum processability, especially by injection molding.

The melt flow rate of component a) is preferably above 15, more preferably above 25 g/10 min (2.16 kg, 230° C.).

The proportion of comonomer in component a) is preferably more than 20% by weight.

Preferred polypropylene copolymers of component a) are poly(propylene/ethylene) copolymers having an ethylene content of from 20 to 45%, preferably from 30 to 40%, by weight.

If component a) is contained, its proportion is preferably above 2% by weight, more preferably above 5% by weight of the polymer mixture.

A polypropylene is employed as component b). It may be a homopolymer or a copolymer as defined above. Also, it may be a metallocene polypropylene (m-PP). In this case, a metallocene catalyst is used in the polymerization. Preferably, component b) is a copolymer of propylene with another olefin, especially ethylene.

Component b) is different from component a) (if component a) is present). Preferably, component b) has a higher flowability as compared to component a). In addition, component b) may have a structure different from that of component a) in the comonomer composition. Preferred are polypropylene copolymers for component b) which include a lower proportion of the comonomer, e.g., ethylene, as compared to component a). However, in this case too, other olefins, such as butene (C₄), hexene (C₆), octene (C₈) or longer-chain olefins, may also be used. Component b) usually has a higher flexural modulus of elasticity as compared to component a), and at least the flexural modulus of elasticity of component b) deviates by at least 20% from the flexural modulus of elasticity of component a). In one embodiment, this flexural modulus of elasticity of component b) is more than 800 MPa. In one embodiment, the flexural modulus of elasticity of component b) is at most 1600 MPa, preferably at most 1100 MPa, more preferably at most 600 MPa.

The melt flow rate is preferably from 30 to 180 g/10 min (2.16 kg, 230° C.), more preferably from 30 to 150 g/10 min (2.16 kg, 230° C.).

Preferred polymers for component b) have a proportion of comonomer, e.g., ethylene, of at most 30%, preferably from 3 to 15%, by weight. Suitable components for component b) are commercially available, for example, under the trade names of Moplen® and Novolen® from the company Basell, Stamylan P® or Vestolen P® from the company DSM/Sabic, Exxon Mobil PP® from the company Exxon Mobil. The corresponding components cause an increase in the stress-cracking resistance of the material. The preferably employed components additionally have a good processability and flowability. The flexural modulus of elasticity is generally increased by the material. The raw material price is within a medium to low range.

If component b) is present, its content is preferably at least 2% by weight, more preferably at least 5% by weight, of the polymer mixture.

A polyolefin which may have either a homopolymeric or a copolymeric structure is employed as component c). This polyolefin is not a polypropylene (PP). However, it may be, for example, polyolefins, such as polybutene-1 (PB-1), polyisobutylene (PIB), poly-4-methylpentene-1 (PMP), or polyethylene (PE).

In many cases, polybutene-1 or polyisobutene bring about an improvement of the stress-cracking resistance and, due to a favorable flowing property, also an improvement in processability, and may also be used in small amounts (less than 25%). Both homopolymers and copolymers are conceivable in these products too. In these products, the raw material cost is to be expected in the medium to upper range.

Polybutenes and polyisobutenes are sold, for example, under the trade names of Polybutene-1 PB 0800M or Polybutene-1 PB 0300M from the company Basell, or Parapol® from the company Exxon Chemical, or Vistanex® from the company Esso Chemie.

Also, component c) may be a polyethylene which may be a homopolymer or a copolymer. This copolymer is different from component a) and component b), if present. Polyethylenes from a wide variety of polymerization types may also be employed. Suitable polyethylenes include, but are not limited to, low density polyethylene (LD-PE) to high density polyethylene (HD-PE), linear low density polyethylene (LLD-PE), very low density polyethylene (VLD-PE), ultra low density polyethylene (ULD-PE), metallocene polyethylene (m-(LLD)-PE), ethylene/vinyl acetate copolymers (EVA). Copolymers of ethylene with butene (C₄), hexene (C₆), octene (C₈) or also longer-chain olefins are also suitable. Further, ethylene/ethyl acrylates copolymers (E/EA), ethyl/methyl acrylate copolymers (E/MA), cross-linked polyethylene (PE-V) or chlorinated polyethylene (PE-C) are suitable. Suitable materials are commercially available, for example, under the trade name Dowlex® from the company Dow Chemical, under the trade name Lupolen® from the company Basell, under the trade names Innovex®, Rigidex® und Novex® from the company BP, under the trade names Stamylex®, Stamylan PE® from the company DSM/Sabic, under Exxon Mobil PE® from the company Exxon Mobil, under the trade name Lutene® from LG Chemical, and under the trade names Riblene®, Flexirene®, Clearflex®, Eraclene® und Greenflex® from the company Polimeri Europa.

Although corresponding polyethylenes often have a poorer stress-cracking resistance, they allow the flexural modulus of elasticity, processability and flowability to be adjusted. In addition, many polyethylenes can be obtained at relatively low cost and thus have a positive effect on the total raw material cost of the polymer.

Also suitable are, for example, cross-linked ethylene/propylene (diene) copolymers (EPDM) in a crystalline or amorphous structure. Such materials are available, for example, from the company Huls under the trade name Buna®, from the company Monsanto under the trade name Santoprene®, from the company Bayer under the trade name Levaflex®, or from the company Exxon Chemical under the trade name Vistalon®.

A definition of polyolefins to distinguish them from one another and from other synthetic plastic materials can be found in the technical book from VDI publishers, “Die Kunststoffe und ihre Eigenschaften” by Hans Domininghaus, 4th Edition, Chapters 2.1.1 to 2.1.1.8.1 on pages 73 to 171.

If component c) is present, its content is preferably at least 5% by weight, more preferably at least 10% by weight, of the polymer mixture.

Component d), which is a methacrylic acid copolymer or acrylic acid copolymer, may be contained as a further component. This material has a very high transparency associated with a good stress-cracking resistance. Also, for many available types, this material is characterized by low values of the flexural modulus of elasticity. Its flowing properties usually do not result in an optimum processability, especially by injection molding. This material is sold, inter alia, by the company DuPont under the trade names Surlyn® and Nucrel®. Surlyn, which is ionically cross-linked, has an even better stress-cracking resistance towards chemically aggressive ingredients in the package.

Preferably, component d) is a copolymer of Ethylene, such as an ethylene/acrylic acid copolymer (E/AA), ethylene/ethyl acrylate copolymer (E/EA), ethylene/methacrylate copolymer (E/MA) or ethylene/methacrylic acid copolymer (E/MM). Component d) is different from component c) if both are contained.

If component d) is present, its content is preferably at least 5% by weight, more preferably at least 10% by weight, of the polymer mixture.

In one embodiment of the invention, the polymer mixture contains two components, i.e., a combination of a)+b), a)+c) or b)+c).

In another embodiment, the polymer mixture contains three components, i.e., for example, a)+b)+c), a)+b)+d), a)+c)+d), or b)+c)+d).

In another embodiment, all of the components a), b), c) and d) are contained.

The polymer mixture may in principle contain further polymers. Preferably, however, the composition does not include a polymer component which does not fall under the definition of components a), b), c) and d); preferably, only a), b) and c) are contained.

In one embodiment of the invention, the content of component a) is from 60 to 80% by weight and the content of component b) is from 20 to 40% by weight. In another embodiment, the three components a), b) and c) are contained. In this case, preferred mixtures are:
1) from 5 to 50% by weight of component a);
2) from 5 to 40% by weight of component b);
3) from 10 to 60% by weight of component c);
   or components b), c) and d) are contained with:
1) from 10 to 30% by weight of component b);
2) from 10 to 40% by weight of component c);
3) from 30 to 80% by weight of component d).

By means of the adjustment of the amounts of each individual raw material component, the property profile of the mixture of materials of the plastic package to be prepared is selectively controlled to achieve an optimum result in terms of the desired properties of stiffness or deformability (represented by the flexural modulus of elasticity), stress-cracking resistance, flowability, transparency and economic efficiency (from lower cost of raw materials).

By adding component a), the flexural modulus of elasticity is selectively lowered, and the stress-cracking resistance increased.

By adding component b), the flowability, stress-cracking resistance and often also the economic efficiency (from lower cost of raw materials) of the mixture of materials are selectively increased.

By adding component c), the flowability and economic efficiency (from lower cost of raw materials) are selectively increased, and the flexural modulus of elasticity is also often selectively lowered. An exception to this are polybutene-1 or polyisobutylene as component c). Of these raw materials, products which have higher flowabilities (MFI) and at the same time a very good stress-cracking resistance are available on the market, so that, when these raw materials are added, the stress-cracking resistance can also be further increased by component c).

By adding component d), the transparency and the stress-cracking resistance are selectively increased, and the flexural modulus of elasticity is also often selectively lowered.

The objective is to obtain a package which has a sufficient stress-cracking resistance for the product being filled. The stress-cracking resistance necessary for the package according to the invention varies depending on the aggressiveness of the product being filled.

For most applications, a dyed package is desired, but in fields of the cosmetic industry, there is also an increasing desire for transparent packages.

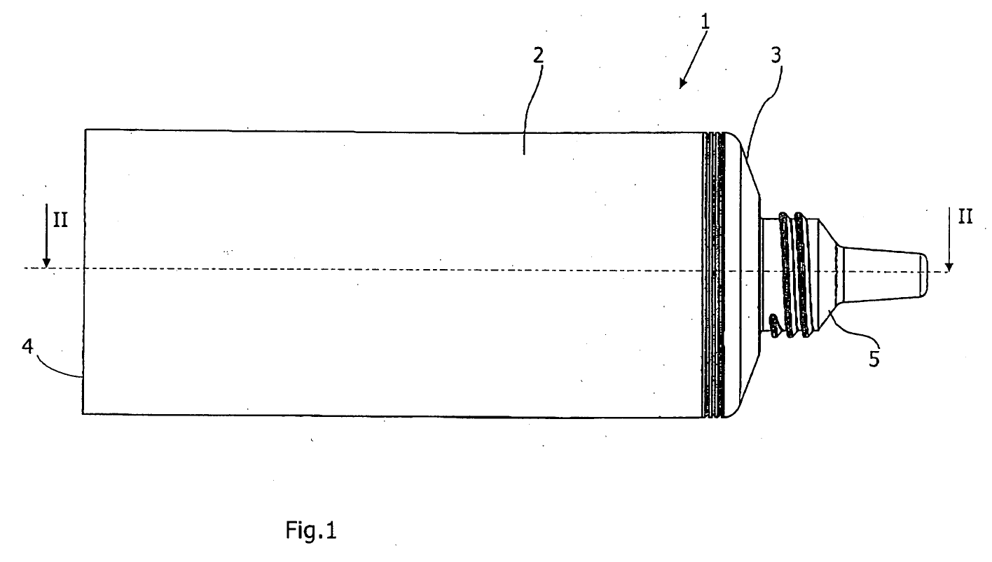

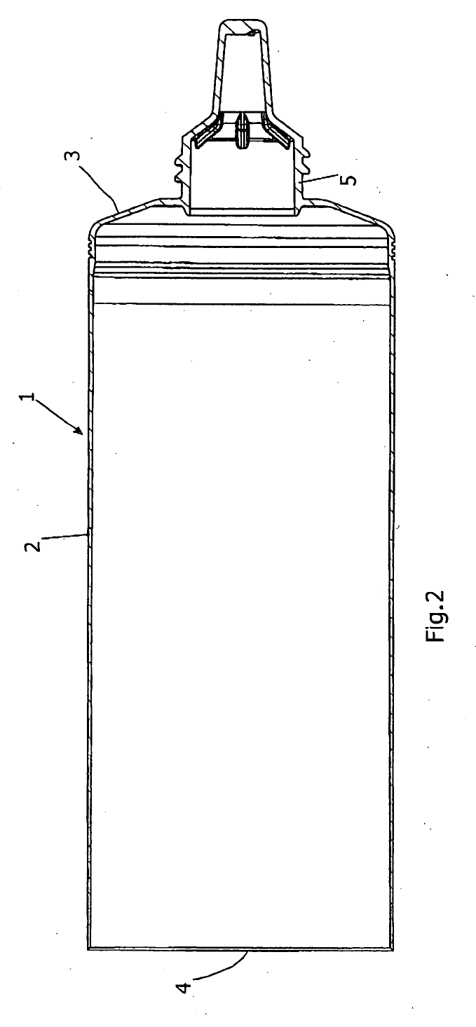

FIGS. 1 and 2 show views of suitable packages.

All the packages according to the invention have in common that the polymer mixture for the package according to the invention preferably has an MFI of at least 3 g/10 min (230° C., 2.16 kg), more preferably at least 30 g/10 min (230° C., 2.16 kg). The determination of the MFI is in accordance with ASTM D 1238. All the packages according to the invention have also in common that the flexural modulus of elasticity of the package according to the invention is preferably at most 1,600 MPa. For packages in which a recovery of shape is desired, for example, for dosing the product, the flexural modulus of elasticity is preferably from 1,000 to 1,200 MPa. For packages which are to be deformed permanently, preferred flexural modulus of elasticity are from 200 to 300 MPa.

As a further common object of the packages according to the invention, the more favorable cost structure in the production of the package as compared to qualitatively similar commercially available packages of the prior art may be mentioned.

Preferably, the package is one-piece and/or one-layer.

One-piece means that the package does not have two parts which are permanently bonded together, but the package body is prepared integrally with a packing shoulder. For example, with a collapsible tube (1), there is no bonding of a head (3) with a body (2) of the collapsible tube. Of course, a tube cap is produced separately for a collapsible tube (1). However, the latter is not permanently bonded to the one-piece collapsible tube. In the tube blank (1), the tube shoulder (3) is contiguous with the front of the tube body (2). Contiguous with the tube shoulder (3), there may be a tube head (5) which may serve for attaching a cap. At the backside end of the tube blank (1), a filling and sealing opening (4) is provided.

The wall thickness of the package is preferably from 0.35 mm to 1.0 mm.

One-layer means that the package reaches its structural integrity by only one layer. Of course, in addition to the one polymer layer, a one-layer collapsible tube may also have further layers of colors or stickers for decorating the collapsible tube. Also, it is possible to apply a special decoration or barrier layer in label form before, during of after the production process. Preferably, the one layer is prepared by injection molding.

In one embodiment, the flexible package is a collapsible tube. It is further preferred that the flexible package is prepared by injection molding. In particular, the process is suitable for preparing by injection molding extended collapsible tubes which have a length of 100 mm or more, preferably 125 mm or more. Typically, the length is not above 250 mm. Typical diameters are from 25 to 50 mm, preferably from 30 to 50 mm.

The flexible packages according to the invention may contain, for example, a cosmetic product, a food, a household product, an adhesive, a sealant, an industrial chemical or similar contents.

The invention further relates to a process for preparing a flexible package of plastic, comprising the step of injection molding a polymer mixture of at least two components selected from:
a) a polypropylene copolymer having a flexural modulus of elasticity of at most 800 MPa and a melt flow rate of at most 600 g/10 min (2.16 kg, 230° C.);
b) a polypropylene other than that of component a) and having a melt flow rate of from 20 to 600 g/10 min (2.16 kg, 230° C.); and
c) a polyolefin other than a polypropylene;
   wherein, if only component a) and component b) are present, component b) is a polypropylene copolymer; and
   wherein, if only component a) and component c) are present, component c) has a melt flow rate of at least 15 g/10 min (2.16 kg, 230° C.).

It is possible to admix other polymers before or during the processing of components a) to d).

The invention further relates to a polymer mixture of at least two components selected from:
a) a polypropylene copolymer having a flexural modulus of elasticity of at most 800 MPa and a melt flow rate of at most 600 g/10 min (2.16 kg, 230° C.);
b) a polypropylene other than that of component a) and having a melt flow rate of from 20 to 600 g/10 min (2.16 kg, 230° C.); and
c) a polyolefin other than a polypropylene;
   wherein, if only component a) and component b) are present, component b) is a polypropylene copolymer; and
   wherein, if only component a) and component c) are present, component c) has a melt flow rate of at least 15 g/10 min (2.16 kg, 230° C.).

### TEST METHODS

The flexural modulus of elasticity is determined according to ASTM D-790 (at 23° C.). The melt flow rate (MFR) or melt flow index (MFI) determined according to ASTM D-1238. Depending on the melting temperature range of the individual raw material, the process is performed at different temperatures. It usually holds for components a) and b) that the measurement is performed at a testing stress of 2.16 kg and at 230° C. due to the higher crystallite melting temperature. For components c) and d), the testing is performed at a testing stress of 2.16 kg and at 190° C. The testing conditions are always stated.

### EXAMPLES

The experiments were performed with an experimental mold on an injection molding machine. The stated amounts of raw materials were added to a container together in the form of pellets and mixed manually. Similarly, it is also possible to add the individual material components directly to the machine at the appropriate percentage mechanically and to mix them. After having been fed, the raw material components are conveyed by the injection molding machine into the plastifying cylinder where they are plastified and homogenized under the action of temperature and shear, followed by injection thereof into the injection mold.

Within the injection mold, the previously plastic polymer mixture cools down to a solid and demoldable temperature level, and the package is then demolded from the injection mold. Subsequently, the thus prepared package may be labeled, if desired, or decorated or finished by other methods usual in the market.

### Example 1

| Component | a) | b) | c) | d) |
|---|---|---|---|---|
| Type of raw | PP copolymer | — | LLD-PE | — |
| material | | | | |
| Designation by | Adflex Z108S | — | Flexirene LLD-PE MS20 | — |
| manufacturer | | | | |
| % by weight | 40% | — | 60% | — |

| | |
|---|---|
| Result | good processing performance with high flexibility of |
| | collapsible tube |

### Example 2

| Component | a) | b) | c) | d) |
|---|---|---|---|---|
| Type of | — | metallocene PP | ULLD-PE | E/MAA |
| raw material | | homopolymer | | |
| Designation by | — | Metocene HM648T | Clearflex MPDO | Surlyn |
| manufacturer | | | | 8660 |
| % by weight | — | 30% | 40% | 30% |

| | |
|---|---|
| Result | high transparency and stress-cracking |
| | resistance |

E/MAA = ethylene/methacrylic acid copolymer

### Example 3

| Component | a) | b) | c) | d) |
|---|---|---|---|---|
| Type of raw | PP copolymer | PP copolymer | LLD-PE | — |
| material | | | | |
| Designation by | Adflex X100G | Moplen EP 240T | Flexirene | — |
| manufacturer | | | LLD-PE MS20 | |
| % by weight | 40% | 20% | 40% | — |

| | |
|---|---|
| Result | good stress-cracking resistance and elasticity of |
| | collapsible tube |

### Example 4

| Component | a) | b) | c) | d) |
|---|---|---|---|---|
| Type of raw material | PP copolymer | PP copolymer | — | — |
| Designation by | Adflex Z108S | Moplen RP 248R | — | — |
| manufacturer | | | | |
| % by weight | 70% | 30% | — | — |

| | |
|---|---|
| Result | very good stress-cracking resistance and |
| | flexibility of collapsible tube |

### Example 5

| Component | a) | b) | c) | d) |
|---|---|---|---|---|
| Type of raw material | — | metallocene PP | ULLD-PE | — |
| | | homopolymer | | |
| Designation by | — | Metocene HM648T | Clearflex MPDO | — |
| manufacturer | | | | |
| % by weight | — | 30% | 70% | — |

| | |
|---|---|
| Result | good transparency and stress-cracking |
| | resistance |

### Example 6

| Component | a) | b) | c) | d) |
|---|---|---|---|---|
| Type of raw | PP copolymer | PP copolymer | ULLD-PE | — |
| material | | | | |
| Designation by | Adflex Z108S | Moplen | Clearflex MPDO | — |
| manufacturer | | EP 240T | | |
| % by weight | 33% | 33% | 34% | — |

| | |
|---|---|
| Result | good stress-cracking resistance and flexibility of |
| | collapsible tube |

### Example 7

| Component | a) | b) | c) | d) |
|---|---|---|---|---|
| Type of raw | PP copolymer | metallocene PP | LD-PE | E/MAA |
| material | | homopolymer | | |
| Designation by | Adflex X100G | Metocene | Stamylan | Surlyn |
| manufacturer | | HM648T | LD1922T | 9970 |
| % by weight | 20% | 30% | 30% | 20% |

| | |
|---|---|
| Result | good transparency and flexibility of |
| | collapsible tube |

### Example 8

| Component | a) | b) | c) | d) |
|---|---|---|---|---|
| Type of | — | PP copolymer | LLD-PE | E/MAA |
| raw material | | | | |
| Designation by | — | Moplen EP240T | Flexirene | Surlyn 8660 |
| manufacturer | | | LLD-PE MS20 | |
| % by weight | — | 20% | 40% | 40% |

| | |
|---|---|
| Result | good transparency and flexibility of collapsible tube |

### Example 9

| Component | a) | b) | c) | d) |
|---|---|---|---|---|
| Type of raw material | PP copolymer | — | PB-1 | — |
| Designation by | Adflex Z108S | — | Basell PB 0300M | — |
| manufacturer | | | | |
| % by weight | 80% | — | 20% | — |

| | |
|---|---|
| Result | very good stress-cracking resistance and |
| | flexibility of collapsible tube |

Less good are even bad results were obtained in the following experimental settings:

### Comparative Example 1

| Component | c) | c) | — | — |
|---|---|---|---|---|
| Type of raw material | LD-PE | LLD-PE | | |
| Designation by | Stamylan LD1922T | Sabic M200024 | | |
| manufacturer | | | | |
| % by weight | 50% | 50% | | |

| | |
|---|---|
| Result | sufficient flexibility of collapsible tube, but |
| | unsuitable stress-cracking resistance |

### Comparative Example 2

| | | | | |
|---|---|---|---|---|
| Component | a) | — | — | — |

| | | |
|---|---|---|
| Type of raw material | PP copolymer | PP homopolymer |
| Designation by | Adflex X100G | Hostalene PPW2080 |
| manufacturer | | |
| % by weight | 50% | 50% |

| | |
|---|---|
| Result | sufficient stress-cracking resistance, but |
| | insufficient flexibility of collapsible tube |

### Comparative Example 3

| | | | | |
|---|---|---|---|---|
| Component | a) | — | — | — |

| | | |
|---|---|---|
| Type of raw material | PP copolymer | PP homopolymer |
| Designation by | Adflex X100G | Hostalene PPW2080 |
| manufacturer | | |
| % by weight | 80% | 20% |

| | |
|---|---|
| Result | sufficient stress-cracking resistance and flexibility |
| | of collapsible tube, but high extent of sticking of |
| | the collapsible tube within the injection mold, |
| | causing production problems |

### Comparative Example 4

| | | | | |
|---|---|---|---|---|
| Component | c) | c) | — | — |

| | | |
|---|---|---|
| Type of raw material | LD-PE | HD-PE |
| Designation by | Stamylan LD1938T | Rigidex 5226EA |
| manufacturer | | |
| % by weight | 75% | 25% |

| | |
|---|---|
| Result | good flexibility of collapsible tube and |
| | producibility, but unsuitable |
| | stress-cracking resistance |

1. A flexible package of plastic with at least one wall, the wall wherein a polymer mixture of at least two components selected from:
a) a polypropylene copolymer having a flexural modulus of elasticity of at most 800 MPa and a melt flow rate of at most 600 g/10 min (2.16 kg, 230° C.);
b) a polypropylene other than that of component a) and having a melt flow rate of from 20 to 600 g/10 min (2.16 kg, 230° C.); and
c) a polyolefin other than a polypropylene;
wherein, if only component a) and component b) are present, component b) is a polypropylene copolymer; and
wherein, if only component a) and component c) are present, component c) has a melt flow rate of at least 15 g/10 min (2.16 kg, 230° C.).

2. The flexible package according to claim 1, wherein said polymer mixture has an MFI of at least 3 g/10 min (2.16 kg, 230° C.) and a flexural modulus of elasticity of at most 1,600 MPa.

3. The flexible package according to claim 1, wherein component a) has a flexural modulus of elasticity of at most 600 MPa, more preferably at most 200 MPa, and/or a flexural modulus of elasticity of at least 20 MPa.

4. The flexible package according to claim 1, wherein, if only components b) and c) are present and component c) is a polyethylene having a density of up to 0.935 g/cm³, b) has a flexural modulus of elasticity of at most 1100 MPa.

5. The flexible package according to claim 1, wherein a methacrylic acid copolymer or acrylic acid polymer is additionally contained.

6. The flexible package according to claim 1, wherein component a) is a polypropylene copolymer with ethylene, especially that component b) has an ethylene proportion of up to 30% by weight.

7. The flexible package according to claim 1, wherein, if component a) is contained, component b) has a flexural modulus of elasticity of at most 1600 MPa.

8. The flexible package according to claim 1, wherein component c) is a homopolymer or copolymer of polyethylene.

9. The flexible package according to claim 1, wherein component c) is selected from the group consisting of polybutene-1 (PB-1), polyisobutylene (PIB), poly-4-methylpentene-1 (PMP), and cross-linked or chlorinated polyethylene ((PE-V or PE-C).

10. The flexible package according to claim 1, wherein component c) has an MFI (190° C., 2.16 kg) of at least 2 g/10 min and a flexural modulus of elasticity of at most 1200 MPa.

11. The flexible package according to claim 1, wherein the content of component a) is from 60 to 80% by weight, and the content of component b) is from 20 to 40% by weight.

12. The flexible package according to claim 1, wherein said polymer mixture has the following composition:
1) from 5 to 50% by weight of component a);
2) from 5 to 40% by weight of component b);
3) from 10 to 60% by weight of component c).

13. The flexible package according to claim 1, wherein the content of component b) is from 5 to 40% by weight, and the content of component d) is from 60 to 95% by weight.

14. The flexible package according to claim 1, wherein said flexible package is a collapsible tube.

15. The flexible package according to claim 1, wherein said flexible package is obtainable by injection molding.

16. The flexible package according to claim 1, wherein said flexible package contains a cosmetic product, a food, a household product, an adhesive, a sealant or an industrial chemical.

17. A process for preparing a flexible package of plastic, comprising the step of injection molding a polymer mixture comprising at least two components selected from:
a) a polypropylene copolymer having a flexural modulus of elasticity of at most 800 MPa and a melt flow rate of at most 600 g/10 min (2.16 kg, 230° C.);
b) a polypropylene other than that of component a) and having a melt flow rate of from 20 to 600 g/10 min (2.16 kg, 230° C.); and
c) a polyolefin other than a polypropylene;
wherein, if only component a) and component b) are present, component b) is a polypropylene copolymer; and
wherein, if only component a) and component c) are present, component c) has a melt flow rate of at least 15 g/10 min (2.16 kg, 230° C.).

18. A polymer mixture comprising at least two components selected from:
a) a polypropylene copolymer having a flexural modulus of elasticity of at most 800 MPa and a melt flow rate of at most 600 g/10 min (2.16 kg, 230° C.);
b) a polypropylene other than that of component a) and having a melt flow rate of from 20 to 600 g/10 min (2.16 kg, 230° C.); and
c) a polyolefin other than a polypropylene;
wherein, if only component a) and component b) are present, component b) is a polypropylene copolymer; and
wherein, if only component a) and component c) are present, component c) has a melt flow rate of at least 15 g/10 min (2.16 kg, 230° C.).
